(19) United States
(12) Patent Application Publication
(10) Pub. No.: US 2017/0005448 A1
(43) Pub. Date: Jan. 5, 2017

(54) FLUSH AND FILL TOOL FOR SUBSEA CONNECTORS

(71) Applicant: Teledyne Instruments, Inc., Thousand Oaks, CA (US)

(72) Inventors: Corey C. Williams, Port Orange, FL (US); Jonathan R. Hatcher, South Daytona, FL (US)

(21) Appl. No.: 14/790,955

(22) Filed: Jul. 2, 2015

(51) Int. Cl. H01R 43/00; G02B 6/44; G02B 6/50

(52) U.S. Cl. CPC H01R 43/005; G02B 6/506; G02B 6/4428

(57) ABSTRACT

A flush and fill tool is configured for releasable mating engagement with a bulkhead mounted connector unit which has an optical contact chamber containing optical fluid. The unit has an outer shell with an open forward end containing a seal assembly designed for sealed engagement with a corresponding seal assembly at the forward end of the mating connector unit. An optical fluid fill reservoir and a capture reservoir for used optical fluid located in the housing are associated with a fill pin and a return pin, respectively, which extend through aligned bores in the seal assemblies into the optical contact chamber in the mated condition. A spring loaded plunger engaged in the fill reservoir injects optical fluid from the fill reservoir through a passageway through the fill pin and into the optical contact chamber, ejecting used oil from the chamber through a passageway in the return pin into the capture reservoir.

### BACKGROUND

1. Field of the Invention

The present invention relates generally to optical and electro-optical connectors for use in harsh environments such as subsea environments, and is particularly concerned with a flush and fill tool or apparatus and method for removing old optical fluid from the optical contact chamber or chambers of such connectors and replacing the removed optical fluid with clean optical fluid.

2. Related Art

There are many types of connectors for making electrical and fiber-optic cable connections in hostile environments. One type includes connectors for undersea mating and de-mating. Such underwater connectors typically comprise a first connector or receptacle unit containing one or more receptacle contacts and a second connector or plug unit containing an equivalent number of plug contacts or contact pins or probes for engagement with the receptacle contacts on mating engagement of the units. Typically, the contacts are contained in a sealed chamber containing dielectric fluid or optical fluid, and the probes enter the chamber via one or more normally sealed openings. One problem in bulkhead optical or electro-optical connector units is sand, silt or debris infiltration into the optical manifold and chamber during mating and demating of the connector units. Another issue is exceeding the recommended mate/demate count for the connector.

A number of different sealing mechanisms have been proposed in the past for releasably sealing subsea connector units during demating. One such sealing mechanism has an opening into the contact chamber which comprises an elastomeric tubular entrance surrounded by an elastomeric sphincter which pinches the entrance closed upon itself when the plug and receptacle units are in an unmated condition. In the mated condition, the sphincter pinches against the entering probe to form a seal. Other Underwater electro-optical connectors are described in U.S. Pat. Nos. 4,616,900 and 4,666,242 of Cairns. In U.S. Pat. No. 4,666,242, the male and female connector units are both oil filled and pressure balanced. This device utilizes a penetrable seal element having one or more openings which pinch closed when the units are separated. Other connectors have rotating seal elements which rotate between closed and open positions during mating to open seal openings and allow contact probes to enter the receptacle contact chamber or chambers on mating.

So called rolling seal connectors, such as the connector described in U.S. Pat. No. 6,017,227 of Cairns et al., are harsh environment or underwater connectors in which dielectric fluid filled contact chambers in the plug and receptacle units are sealed at the forward ends of the connectors by rolling seals which have through bores aligned with respective bores in the two units in the mated condition, and offset from the bores connected to the contact chambers so as to seal the chambers in the unmated condition. One or more actuators in one of the units are designed to extend into the other unit on mating and to engage with seal actuator tabs in both units during mating to roll the seals from the closed to the open position. The same actuators are designed to engage the seal actuator tabs in the opposite direction during de-mating, to roll the seals back into the closed, sealed condition.

One problem with subsea mateable connector units is that sand, silt or debris may infiltrate the optical fluid chamber after repeated mating and de-mating, resulting in optical issues.

### SUMMARY

Embodiments described herein provide for a tool or apparatus that allows for flushing and replenishment of fluid in a deployed, bulkhead optical or electro-optical connector unit, such as a rotating seal or rolling seal connector unit.

According to one aspect, a flush and fill apparatus for a fixed or bulkhead mounted subsea connector unit is provided. In one embodiment, the apparatus or tool comprises an outer shell with an open forward end, a front seal assembly in the forward end portion of the outer shell configured for sealing engagement with a corresponding connector seal assembly at the forward end of a mating subsea connector unit and having at least first and second seal openings configured for alignment with corresponding openings in the connector seal assembly in a mated condition of the tool and connector unit, a flush and fill assembly mounted in the outer shell behind the seal assembly and comprising a transverse wall having a plurality of passageways aligned with respective seal openings in the seal assembly at least in the mated condition of the tool, a fill reservoir and a return reservoir mounted behind the transverse wall and connected to respective first and second passageways in the transverse wall, each reservoir having a forward end and a rear end, and a fluid injection or fill pin and a fluid return pin projecting forward from the respective first and second passageways in the transverse wall and each having a through bore communicating with the respective first and second passageways. In one aspect, the fill and return pins are configured to extend through the respective first and second seal openings at least in the mated condition of the tool into sealing engagement with aligned openings in the connector seal assembly to communicate with a connector contact chamber of the mating subsea connector unit. The fill reservoir contains optical fluid in an unmated start condition of the tool, and a fill plunger is sealably and movably mounted in a rear end portion of the fill reservoir. A biasing device associated with the fill plunger is configured to push the fill plunger towards the front end of the reservoir after the tool is mated with the subsea connector unit, whereby optical fluid is ejected from the fill reservoir and injected into the contact chamber in the mated connector unit through the first passageway and fill pin through bore, and used optical fluid is flushed from the contact chamber through the return pin through bore and second passageway into the return reservoir. The fill and return reservoirs are of predetermined volume sufficient to flush all used optical fluid from the connector contact chamber into the return reservoir and replace the flushed optical fluid with new optical fluid from the fill reservoir.

In one embodiment, the subsea connector is a rolling seal connector and the seal assembly in the fixed connector unit comprises one or more rolling seals which are actuated by actuator members or rods in the connector unit which extend into aligned openings at the forward end of the tool to rotate the connector unit seal between the closed and open position on mating and from the open to the closed position as the parts are disconnected or de-mated. The seal in the tool seal assembly in this embodiment comprises at least one cylindrical seal of similar design to the rolling seal in the connector unit, and has through bores for alignment with corresponding bores in the rolling seal in the mated condition. In one embodiment, the through bores are sealed in the unmated condition and are opened by movement of the pins through the bores on mating engagement with the fixed connector unit. In one embodiment, the bores are sealed at their forward ends by a thin membrane which is pierced by the pins as the tool is mated to the bulkhead connector unit.

In one embodiment, the flush and fill tool is designed with a seal and actuator mechanism substantially matching that of a plug or flying connector unit mateable with the bulkhead mounted connector unit, but arranged to be partially mated to the bulkhead connector, so that the pins do not engage aligned optical contacts in the contact chamber when the tool is in mated engagement with the connector unit (unlike the mated condition of the plug and receptacle units). The tool is configured so that the outer ends of the fill and return pins are spaced from the optical contacts in the mated condition during flushing and filling of the contact chamber.

The injection pin or probe has an inner end in communication with the clean or unused optical fluid reservoir and the return pin or probe has an inner end in communication with the captured or return fluid reservoir, respectively. Once the tool is connected with the connector unit with the pins extending into the optical fluid-filled chamber or in communication with the chamber, a piston in the fill reservoir is actuated to force clean optical fluid out of the reservoir and through the injection or fill pin into the optical contact chamber, flushing old optical fluid from the chamber and through the return pin into the return fluid chamber or reservoir. The force for fluid injection is provided by a suitable biasing device which advances the plunger in the clean fluid reservoir to eject fluid from the reservoir and into the bulkhead mounted connector unit. The piston may be actuated by a quick release actuator either manually or via an ROV. One way valves in the fluid passageways between each reservoir and through the pins block backflow from the chamber into the fill reservoir and from the return reservoir into the contact chamber during mating and operation of the tool. Once the flushing procedure is complete, the tool is retracted away from the bulkhead connector unit, with the stationary “rolling” seal or seals biased into sealing engagement with the connector unit seals until those seals are rotated back into the closed and sealed condition.

In one embodiment, a forward end of the seal assembly in the tool is configured for face to face engagement with a forward end of a receptacle unit seal assembly, and has one or more cylindrical seals with seal openings corresponding in number to the seal openings in the mating bulkhead connector unit. The tool also has the same number of pins as the seal openings, with each pin aligned with a respective seal opening. One of the pins is the fill pin and a second pin comprises the return pin. The remaining pins are all dummy pins with no through bores designed for sealing engagement in corresponding openings in a rolling seal of the fixed connector unit. The pins are of suitable rigid material and are of shape and dimensions substantially matching those of a flying connector or plug unit designed for mating engagement with the fixed connector unit with which the tool is to be used. The pins may be shorter in length than those of the flying connector unit in some embodiments. The injection and return pins and dummy pins are designed for projecting out of the openings and through the seal member bores into the aligned receptacle unit bores when the seal members are in the open position. At least one actuator in the receptacle projects through an aligned bore in the tool when mated, the actuator rod having a formation for moving the rolling seals of the connector unit back and forth between the closed and open positions.

In one embodiment, the optical fluid fill or supply reservoir and the captured fluid reservoir which receives old fluid flushed from the receptacle contact chamber are both pressure compensated chambers. The fill reservoir contains a sufficient amount of optical fluid to fill and flush the optical chamber of the deployed connector unit.

Other features and advantages of various embodiments will become more readily apparent to those of ordinary skill in the art after reviewing the following detailed description and accompanying drawings.

### BRIEF DESCRIPTION OF THE DRAWINGS

The details of various embodiments of a subsea connector flush and fill tool, both as to its structure and operation, may be gleaned in part by study of the accompanying drawings, in which like reference numerals refer to like parts, and in which:

FIG. 1 is a front perspective view of one embodiment of a flush and fill tool for a rolling seal connector;

FIG. 2 is a front end elevation view of the tool of FIG. 1, illustrating the ROV (remotely operated vehicle) handles;

FIG. 3 is cross-sectional view of the flush and fill tool on the lines 3-3 of FIG. 1, in the unmated condition;

FIG. 4 is a front elevation view of a bulkhead mounted or fixed rolling seal connector unit;

FIG. 5 is a partial cross-sectional view illustrating the flush and fill tool of FIGS. 1 to 3 aligned with a bulkhead mounted rolling seal connector unit ready for mating engagement with the connector unit;

FIG. 6 is a longitudinal cross-sectional view illustrating the flush and fill tool seal in sealed mating engagement with the rolling seal of the mating connector unit with the pins of the tool extending through aligned through bores in the tool and connector unit seals;

FIG. 7 is a longitudinal cross-sectional view similar to FIG. 6, with the fill actuator in the tool released so that optical fluid is injected from the injection chamber into the connector chamber and old fluid is flushed from the connector chamber into the return or fluid collection chamber in the flush and fill tool; and

FIG. 8 is a partial view of forward end portions of the mated tool and connector units in the flushing condition of FIG. 7 on an enlarged scale, illustrating the fill and flush paths more clearly.

### DETAILED DESCRIPTION

Certain embodiments as disclosed herein provide for a flush and fill tool for flushing and replacing old optical fluid from one or more contact chambers in a bulkhead mounted optical or electro-optical connector unit with unused or recycled optical fluid.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention.

The drawings illustrate embodiments of a flush and fill tool for flushing and replenishment of optical fluid into a deployed bulkhead optical connector unit which is designed for releasable mating engagement with a matching connector unit at the end of a cable. Although the tool is designed for mating engagement with an optical connector unit in the illustrated embodiment, the tool may also be designed for mating with an electro-optical unit in alternative embodiments. The tool may be used for replacing optical fluid in a connector designed for use in any harsh environment, not only underwater or at great ocean depths, although it is particularly intended for use in subsea applications.

The tool of the following embodiments is designed for replenishing optical fluid in bulkhead mounted rolling seal connector units for use in a harsh environment or underwater connector, for example the rolling seal optical or hybrid electro-optical connectors of Teledyne ODI, as described in U.S. Pat. No. 6,017,227 of Cairns or US Pat. App. Pub. No. US 2015-0036986 of Kretschmar et al., the contents of both of which are incorporated herein by reference. Rolling seal connectors have a fixed, bulkhead mounted receptacle unit and a flying connector or plug unit at the end of a subsea cable which is releasably mateable with the receptacle or bulkhead unit. In the unmated condition, a contact chamber in the receptacle unit is sealed at its forward end by one or more rolling seals which have through bores aligned with respective optical contacts in the mated condition, and offset from the optical contacts and contact chamber openings so as to seal the chambers in the unmated condition. One or more actuators in the bulkhead connector unit are designed to extend into the flying or plug unit on mating and to engage with seal actuator tabs in both units during mating while the receptacle seal manifold carrying the seals is urged inward into the receptacle shell, so that the seals are rolled from the closed to the open position. The same actuators are designed to engage the seal actuator tabs in the opposite direction during de-mating, to roll the seals back into the closed, sealed condition. When the plug unit engages the forward end of the receptacle unit, the rolling seals in both units are rotated into the open position so that contacts in the plug unit can project through the aligned openings and contact the aligned contacts in the receptacle unit. As noted above, one problem with such connectors is that they have a limited mate count as a result of sand, silt or debris which tends to enter the optical manifold of the bulkhead unit after repeated mating and demating, resulting in poor optical performance. This typically requires recovery of the bulkhead unit for maintenance or replacement.

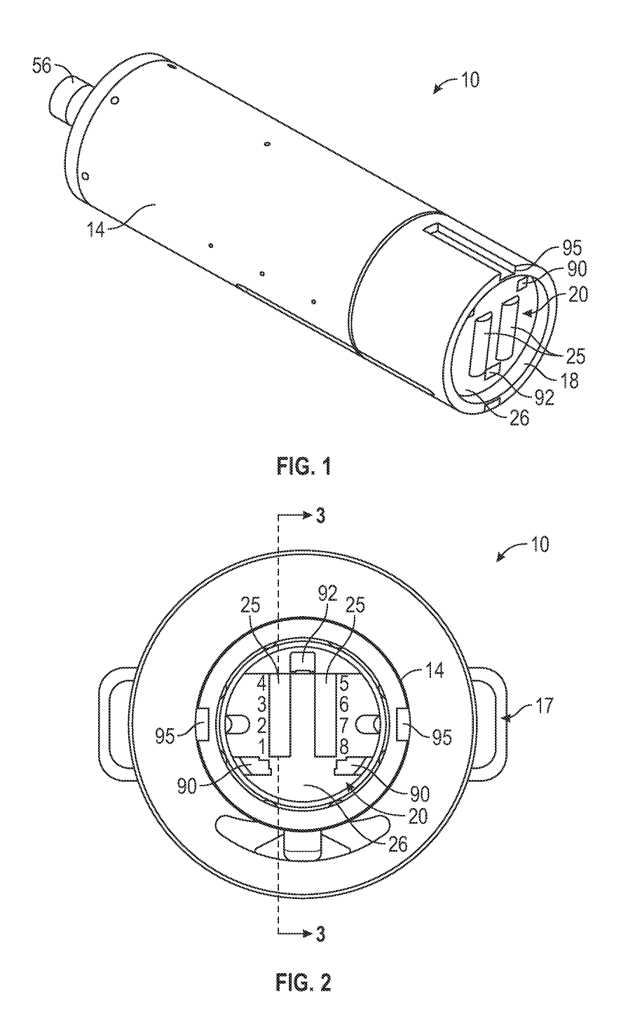

FIGS. 1 to 8 illustrate a flush and fill tool 10 which is designed to mimic parts of a standard flying or plug unit of a rolling seal connector so that it can be releasably mated with the matching fixed subsea receptacle unit of the rolling seal connector. Tool 10 has pins designed for engaging through the rolling seal or seals of the bulkhead mounted connector unit or receptacle unit 12 on mating engagement with that unit. In other embodiments, similar tools may be designed for replenishing optical fluid in bulkhead mounted connector units having different types of seals for sealing the contact chamber, such as annular end seals which rotate about the axis of the connector unit to move between sealed and open positions, or seals with openings sealed by stoppers which are urged inward on mating of the connector units. In such alternative embodiments, it will be understood that the tool has an open end sealed by a seal assembly which is similar to the connector seal assembly of the fixed subsea connector unit and designed for sealing engagement with the connector seal assembly during mating and de-mating.

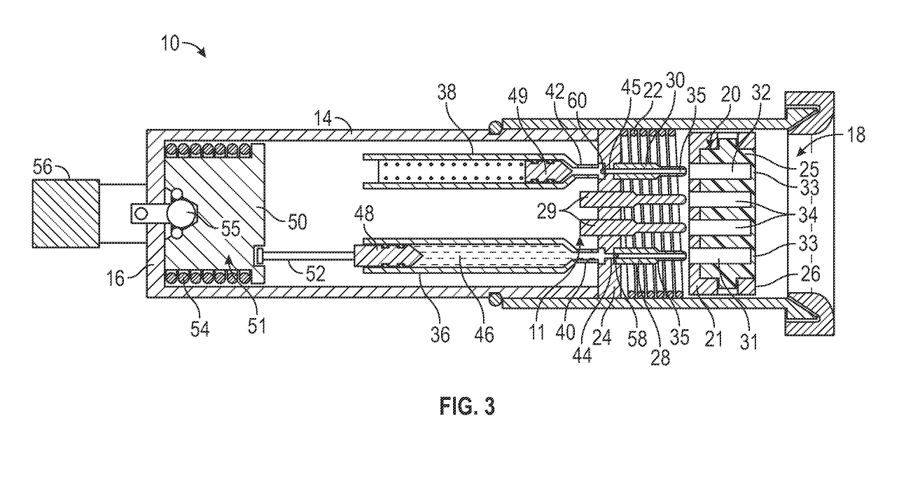

FIGS. 1 to 3 illustrate the flush and fill tool 10 in the unmated condition. The tool or unit 10 comprises an outer cylindrical shell 14 of rigid material having a sealed rear end wall 16 and an open forward end 18. An ROV handle mechanism 17 identical to that of the flying connector unit or plug unit which it is designed to mimic is provided at the rear end of shell 14, as illustrated in FIG. 2 (not illustrated in FIG. 1). As best illustrated in FIG. 3, a front seal assembly 20 is slidably mounted in the forward end portion of the shell and is biased or pre-loaded by biasing spring 22 into the extended or forward position seen in FIGS. 1 and 3. Biasing spring 22 acts between a fixed transverse wall or mounting block 24 inside the shell and the rear end of seal assembly 20. The front seal assembly 20 comprises a front end wall or seal manifold 21 and one or more cylindrical seals 25 mounted in seal manifold 21 with forward end portions projecting outward from the front face 26 of the manifold, as seen in FIG. 1. Each seal 25 has a plurality of seal openings or bores 31, 32 and 34. The number and position of the seal openings corresponds to the number and positions of seal openings of a front seal assembly of a bulkhead or fixed subsea connector unit with which the tool is intended to be mated.

A flush and fill assembly 11 is mounted in the shell behind the seal assembly 20, and basically comprises transverse wall or mounting block 24 having first and second passageways 44, 45 aligned with respective seal openings in the seal assembly at least in the mated condition of the tool, a fill reservoir 36 and a return or captured fluid reservoir 38 mounted behind the transverse wall and in communication with the respective first and second passageways in the transverse wall, a fluid injection or fill pin 28 and a fluid return pin 30 projecting forward from the respective first and second passageways in the transverse wall, and solid dummy pins 29 also projecting forward from wall 24. Each pin 28, 30 has a forward end and a rear end and a through bore or passageway 35 between the forward and rear ends communicating with the respective first and second passageways 44, 45. In an alternative embodiment, fill and return pins 28, 30 may project through wall 24 and communicate directly with reservoirs 36 and 38, respectively.

In the illustrated embodiment, the forward ends of the seal bores 31, 32 and 34 are sealed by a thin membrane 33. Fill pin 28 and return pin 30 are aligned with first and second bores 31 and 32, respectively. The other pins 29 are solid, dummy pins and are aligned with the other two bores 34. The total number of pins per seal depends on the number of contacts associated with each rolling seal of the fixed connector unit with which the tool is intended to be used. In the illustrated embodiment, four pins are associated with each seal but a different number of pins and corresponding seal bores may be provided in other embodiments. There are two rolling seals 25 in the illustrated embodiment, and each seal is associated with a separate set of four pins, with only one set of pins and one seal visible in FIG. 3.

In the illustrated embodiment, the two dummy pins 29 also project outwardly from transverse wall 24 toward the seal 25, in alignment with respective seal bores 34. A greater number of dummy pins may be provided in other embodiments, depending on the number of seal bores which in turn depends on the number of openings or bores in an opposing seal member of the mating connector unit. Additionally, the illustrated embodiment has two front seals in front end wall 21 which each have four seal openings, but there may be one or three or more seals in alternative embodiments, depending on the number of rolling seals in the connector unit with which the tool is to be mated. In the illustrated embodiment, four additional dummy pins (not visible in the drawings) extend from transverse wall 24 in alignment with openings in the second seal 25, and the injection and return pin are both aligned with openings in the first seal 25. In alternative embodiments return pin 30 may be replaced with a dummy pin, and the return pin with through bore 35 may instead be positioned in alignment with one of the openings in the second seal 25, with the second passageway 45 and return reservoir aligned with the return pin associated with the second seal. In this alternative, each seal has three openings or bores aligned with respective dummy pins, and one opening or bore aligned with the respective injection or return pin. In one embodiment, the pins are of substantially matching shape and dimensions to the pins of a flying connector or plug unit designed to mate with the bulkhead connector unit during normal operation of the subsea connector.

A greater or lesser number of rolling seals and associated sets of pins may be provided in other embodiments, depending of the number of rolling seals in the fixed or bulkhead unit with which the tool is to be mated and the number of openings in each seal, which in turn depends on the number of connections to be made between the bulkhead and mating connector unit, such as four, six, seven, eight, nine, ten or twelve or more.

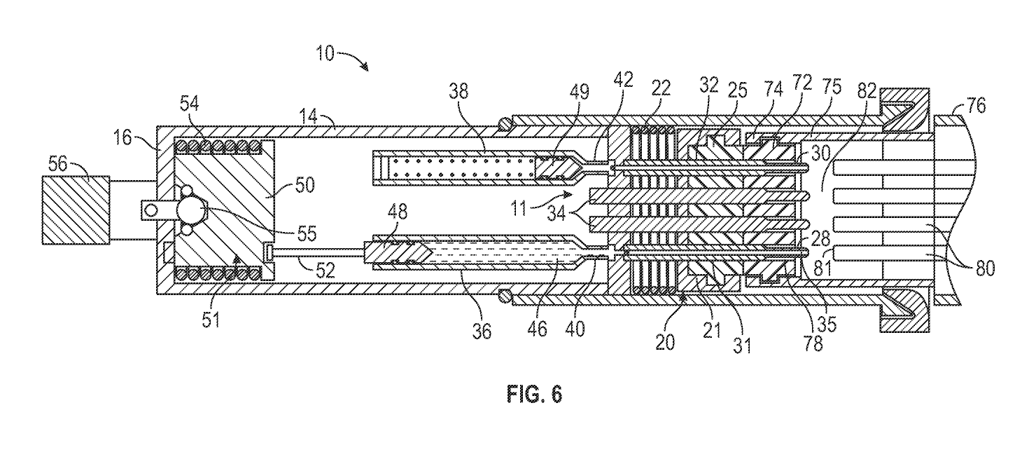

As best illustrated in FIG. 3, fill reservoir 36 and return reservoir 38 are mounted inside the shell behind transverse wall or mounting block 24 and each has an opening or passageway 40, 42 respectively, at its forward end which communicates with the respective first and second through bores or passageways 44, 45 in mounting block or transverse wall 24, or directly with the fill and return pin bores in an alternative embodiment. Reservoir 36 is initially filled with unused or recycled optical fluid 46 and a plunger 48 is slidably and sealably mounted in the rear end of the reservoir chamber. Reservoir 38 initially contains no fluid or only a small amount of fluid and a plunger 49 is slidably and sealably engaged in the forward end of the reservoir chamber in the unmated condition illustrated in FIG. 3. Plunger 49 may be urged by spring 39 into the forward position illustrated in FIG. 3. A biasing device 51 is associated with plunger 48 to urge the plunger into an advanced position when released by quick release device 55. In the illustrated embodiment, biasing device 51 comprises a piston 50 slidably mounted in the rear end of shell 14, an actuator rod 52 between the piston and plunger 48, and a main spring 54 which biases the piston forwards towards the reservoirs when the piston is released by quick release device 55. Quick release device or actuator pin 55 holds the piston 50 and plunger 48 in the retracted positions of FIG. 3 until it is released via external handle or ROV operable device 56. As indicated, the outer end of latching or actuator pin 55 is pivotally connected to release handle 56, and the piston is released when the actuator pin 55 is pulled rearward out of the actuator pin opening and past the actuator latching spring 57 by an ROV engaging handle 56. The latching force may be provided by a BAL Seal canted coil spring 57 in the latching configuration, as illustrated in FIGS. 3 and 6. The pin may be pulled axially in a 20° force cone and still release. This force cone allows for the ROV's lack of fine motor skill. A shackle connected to the actuator pin retains the pin in place and connects to an ROV-operated handle or rope which allows the ROV to pull rearward on the pin, releasing piston 50.

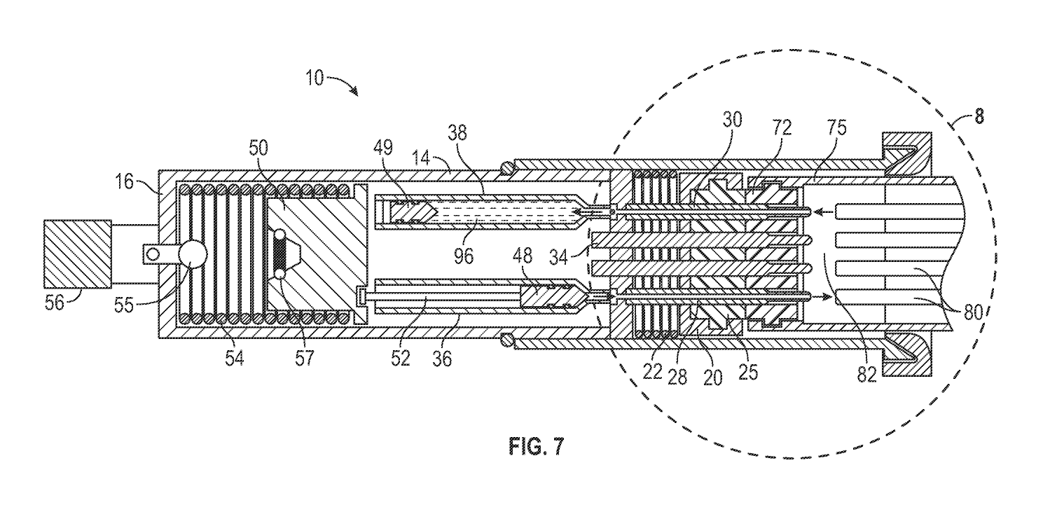

The actuator latching spring 57 secured within a frusto-conical shaped indent at the rear end of piston 50 engages the head of actuator pin 55 and holds the actuator pin and piston in place in the retracted position. When the actuator pin 55 is moved out of the indent and away from the latching spring, the biasing force of the piston spring 54 moves the piston 50 forward, urging plunger 48 forwards to eject fluid from the reservoir 36, as described in more detail below in connection with FIG. 7. The reservoirs may be pressure compensated chambers with internal bladders containing fluid and one or more seawater vents in outer shell 14 and the outer reservoir walls for pressure compensation, as is commonly used for pressure compensation in subsea optical or dielectric fluid chambers of various known subsea connectors.

The first stepped through bore 44 in mounting block 24 is aligned with the through bore 35 in fluid injection or fill pin 28 at one end and with the fill reservoir outlet passageway 40 at the opposite end. The second stepped through bore 45 is similarly aligned with through bore 35 in fluid return pin 30 at one end and the inlet passageway 42 of the fluid reservoir or return chamber 38 at the opposite end. A one way valve 58 seals the outlet passageway 40 of clean fluid reservoir 36 while one way valve 60 seals the inlet or return passageway 42 to captured fluid reservoir 38 both in the unmated condition of FIG. 3 and in the mated but non-actuated condition of FIG. 5. Valves 58 and 60 may be spring loaded ball valves in one embodiment, but other types of pressure actuated one way valves may be used in alternative embodiments.

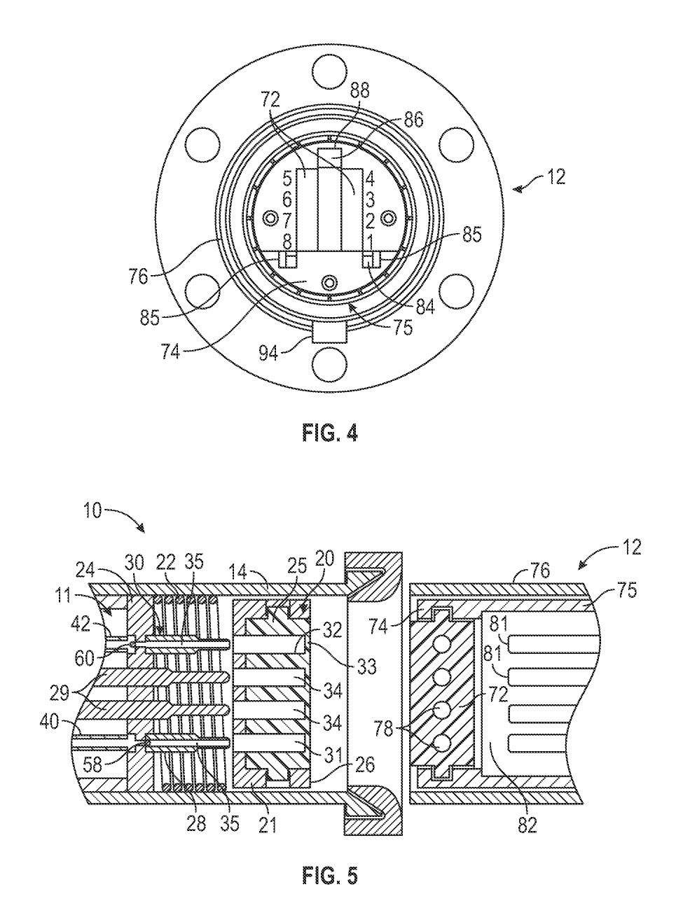

The flush and fill tool 10 of FIGS. 1 to 3 is designed for mating engagement with the corresponding bulkhead mounted or fixed optical or hybrid electro-optical connector unit 12 as illustrated in FIG. 4 and partially illustrated in FIGS. 5 to 8, in place of the mating flying connector or plug unit at the end of a subsea cable or the like, when required for maintenance purposes. As illustrated in FIG. 4, two rolling seals 72 are rotatably mounted in mating part-cylindrical recesses in front end wall or manifold 74 of inner housing 75 inside outer shell 76 of the connector unit 12. In this embodiment, each rolling seal 72 has four openings or through bores 78 which are rotated between the closed and sealed condition of FIGS. 4 and 5 and the open condition of FIGS. 6 to 8 on mating engagement with the flush and fill tool 10 (or a matching plug unit or flying connector unit). One rolling seal is located in one half of manifold or end wall 74, and the other rolling seal is located in the other half of the manifold 74, as best illustrated in FIG. 4. Optical stems 80 with contact ferrules 81 at their forward ends extend into pressure compensated optical contact chamber 82 inside the inner housing 75 in alignment with the respective through bores 78 in the mated condition of the connector unit, and the through bores communicate with the chamber in the mated condition, and are sealed in the unmated condition, as is known in the field. Chamber 82 is filled with suitable optical fluid as is well known in the field of subsea mateable optical and electro-optical connectors.

A pair of actuator rods 84 fixed in the base or end wall of the shell extend slidably through respective passageways 85 in manifold block 74, and a third actuator rod 86 is fixed at one end in the end wall and extends slidably through passageway 88 between the rolling seals 72. The ends of the actuator rods are seen in FIG. 4. The actuator rods are designed to extend out of the open end walls of the respective receptacle manifold passageways during mating engagement between a bulkhead fixed connector unit and a cable mounted flying connector unit when the manifold is urged inward (as described in U.S. Pat. No. 6,017,227 referenced above), so as to rotate the rolling seals in both units between the closed and sealed condition and the open condition during mating, and are retracted back into the passageways when the units are de-mated to roll the seals back into the sealed and closed position. Since this type of rolling seal connector and actuator arrangement is well known in the field and described in the patents cited above, it will not be described in any more detail herein.

The front end manifold or wall 21 of the flush and fill tool is provided with corresponding passageways 90 and 92 for alignment with actuator rods 84 and 86 in the bulkhead unit during mating of tool 10 and connector unit 12. One or more alignment keys or tabs 94 (FIG. 4) on the outer shell 76 of fixed connector unit are designed to engage in mating grooves or slots 95 (FIG. 2) of the tool outer shell 14 during mating engagement of the units, to ensure that the rolling seals and actuator rods are properly aligned with the corresponding seals and actuator rod receiving passageways of the tool.

The receptacle rolling seals have rigid axles while the remainder of the seal is of elastomeric material. In the illustrated embodiment, the tool seals are fixed and may be completely elastomeric or may have rigid cores. As noted above, prior to connection of the tool and receptacle units in this embodiment, each of the elastomeric seals 25 and 72 projects partially outwardly from the respective tool and receptacle manifold end face, as best illustrated in FIGS. 1 and 5. As the tool is moved into engagement with the receptacle or bulkhead unit 12 in the proper relative orientation, the middle actuator passageway 88 in wall or manifold 74 is aligned with port or passageway 92 in the front wall or manifold 21 of tool seal assembly 20, while passageways 85 carrying actuator rods 84 are aligned with the ports or passageways 90 of FIG. 2.

FIG. 5 illustrates the front end portion of tool 10 aligned with the front end portion of the bulkhead or fixed connector unit 12 prior to engagement with unit 12. The connector units are pressed together in the first stage of mating operation, in which the projecting forward portions of the tool seals 25 and receptacle rolling seals 72 are flattened, effectively expelling water from between their opposing faces and sealing the faces of the rolling seals of the receptacle or connector unit to those of the tool. There may be debris trapped between the opposing seal faces at this point. As the tool is pushed further towards the receptacle unit 12, spring 22 in tool shell 14 begins to compress as the seal assembly 20 is urged inwardly. At the same time, the actuator rods start to protrude outwardly from the end wall of receptacle manifold 74 and move into the aligned ports 90, 92 in the front end manifold or wall 21 of seal assembly 20. Movement of actuator rod 86 rotates the rolling seals 72 in the receptacle end face into the open position, simultaneously sweeping away any debris trapped between the opposing seal faces. The openings or through bores 78 in the rolling seals are rotated through ninety degrees into alignment with bores 31, 32 and 34 in the tool “non-rolling” seals 25. At the same time, retraction of seal assembly 20 inwards causes the pins 28, 29 and 30 to extend through bores 31, 32 and 34, respectively, piercing the membrane seals 33 at the outer end of each bore and extending into sealing engagement with the aligned bores 78 in seals 72 of the fixed connector unit, and into the optical chamber or chambers 82, as illustrated in FIG. 6. At this point, passageways 35 through the fill and flush pins 28 and 30 are in communication with chamber or chambers 82 but spaced from optical contacts 81. At the same time, the dummy pins 29 are in sealing engagement with the other two bores 78 in each seal 72, reducing or eliminating the risk of seawater entering the bores. As noted above, the shape and dimensions of the pins substantially match those of the flying connector unit designed to mate with the bulkhead connector unit, but the dimensions may be modified to ensure that the ends of the pins

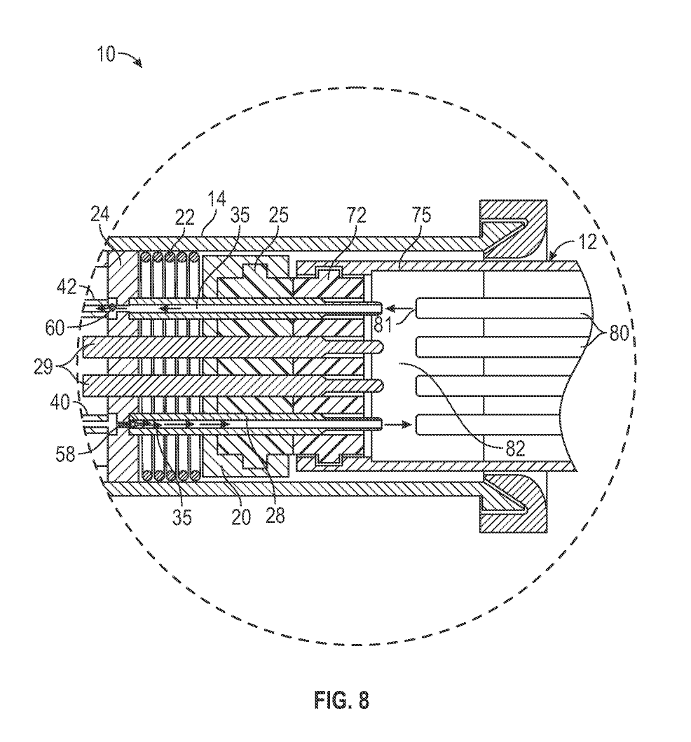

Once the tool 10 is properly mated with the bulkhead connector unit 12 as in FIG. 6, pull handle 56 is actuated to release the head of actuator pin 55 from spring 57, which simultaneously releases spring loaded piston or actuator 50. Piston 50 then urges the plunger 48 in fill reservoir or chamber 36 forwards into the advanced position shown in FIG. 7, forcing optical fluid 46 out of the passageway 40, opening valve 58 and allowing optical fluid to travel past valve 58 through passageway 35 in pin 28 and into chamber 82, as best illustrated by the arrows in FIG. 8. The force for injection of optical fluid from chamber 36 into the contact chamber 82 is provided by spring 54. Optical fluid from chamber 36 therefore fills chamber 82 and flushes old or dirty optical fluid from chamber 82 into return passageway 35 through pin 30, as also illustrated by the arrows in FIG. 8. The return fluid forces one-way valve 60 into the open position shown in FIG. 8, allowing the fluid to flow past open valve 60 and into the inlet 42 of used fluid capture reservoir 38. The captured fluid 96 flowing into reservoir pushes the plunger 49 rearwards into the refracted position, as illustrated in FIG. 8.

The one way valve 58 prevents backflow from optical chamber 82 into clean fluid reservoir 36 during mating of the tool with the bulkhead connector unit 12. The backflow direction of one way valve 60 is reversed from that of valve 58, so that used optical fluid cannot flow back from capture reservoir or chamber 38 into optical chamber 82 during flushing or during de-mating when the flush or fill procedure is complete.

The reservoir 36 contains at least the same amount of optical fluid as the contact chamber in the bulkhead connector unit 12, and may contain more optical fluid than chamber 82 to ensure sufficient flushing of chamber 82, and return fluid reservoir 38 has the same capacity as reservoir 36, so that all or substantially all old or dirty optical fluid is flushed from the chamber 82 into return reservoir 38 when the plunger 48 is in the advanced position illustrated in FIGS. 7 and 8. In the illustrated embodiment, there are two rolling seals in the bulkhead unit 12 associated with a common optical contact chamber, and thus two corresponding “non-rolling” seals 25 in the slidably mounted front manifold or wall 21 of the tool. In this embodiment, the fill and return paths are provided by a fill pin 28 and a flush or return pin 30 both extending through one of the seals, as illustrated in FIGS. 3 and 5 to 8. The second seal 25 is identical to the first seal, and is aligned with the second rolling seal 72 of bulkhead connector unit 12, but the pins in the second seal 25 in this embodiment are all solid, dummy pins which simply act to extend into and seal all the bores or passageways 78 in the mating connector unit seal 72 when the tool is mated with the bulkhead connector unit. In alternative embodiments, one of the seals may be associated with the flush or fill pin 28 while the other seal is associated with the return pin connected to the return chamber or reservoir, and in that case the other three pins associated with each seal are solid, dummy pins identical to the dummy pins 29 of the illustrated embodiment. In this case, clean optical fluid is injected into the contact chamber 82 through one of the seals and old optical fluid is returned through the other seal. Any suitable configuration of injection and collection options through one or both seals may be used in alternative embodiments.

Once the contact chamber has been completely flushed and re-filled with new or recycled optical fluid, the tool 10 is separated from the connector unit the same way as a mating flying connector unit or plug unit at the end of a cable would be separated from the bulkhead unit. As the units are de-mated, the movements described above are reversed as the return spring in the bulkhead unit pushes the receptacle manifold 74 outward relative to the seal actuator rods, with actuator rod 86 (FIG. 4) acting to rotate rolling seals 72 back in the opposite direction until they are in the fully closed position of FIG. 5 again. At the same time, the front end manifold 21 of tool 10 is urged outward by spring 22 as the tool is retracted away from bulkhead connector unit 12, maintaining sealing contact between seals 25 and 72 as the seals 72 roll back into the sealed condition and pins 28, 29 and 30 are retracted back out of the seal bores 78. This arrangement helps in preventing or substantially preventing any seawater from entering the sealed oil chamber of the bulkhead connector or receptacle unit as the tool is separated from that unit. The one way valves 58, 60 in the respective fluid passageways in the tool are also biased back into the closed and sealed condition during de-mating so that no backflow occurs in either direction.

The subsea connector flush and fill tool described above has two cylindrical seals each having four through bores and associated sets of four pins for extending through the seals of the tool and the mating connector unit to allow flushing of old optical fluid and filling with new optical fluid. However, a similar tool may be provided in alternative embodiments with a greater or lesser number of cylindrical seals for use with bulkhead connectors with one, three or more rolling seals, or with cylindrical seals having a different number of through bores. The tool 10 has a corresponding number of pins for mating with bulkhead connector seals which have the same number of through bores or passageways through the seal. The tool may be configured for mating with rolling seal bulkhead connector units having 6, 7, 8, 9 or 12 way configurations, and may be customized for any specific contact and seal arrangement, as well as for flushing optical chambers of hybrid electro-optical connectors. Additionally, the above embodiment has cylindrical seals or seal members designed for sealing engagement with corresponding cylindrical rolling seals of the mating bulkhead connector unit, but flush and fill tools of alternative embodiments may have seals of different shape and design matching those of different types of bulkhead connector units, such as connector units with rotating seal members of disc-shape which rotate about the central longitudinal axis of the connector unit, rather than transverse to that axis as is the case with rolling seal connectors. It will be understood that rollable shapes other than cylindrical may be used for the mating seals and recesses, such as spherical or part-spherical, and the tool is designed with appropriate rolling or other shaped seals matching those of the bulkhead mounted connector unit with which it is sealably engaged during flushing and filling of the optical contact chamber or chambers.

The subsea connector flush and fill tool described above allows for flushing of old optical fluid and replenishment of unused or recycled optical fluid into a deployed bulkhead optical or hybrid electro-optical connectors, without the need to remove subsea deployed hardware for maintenance at a remote ship or land location. The tool allows for correction of optical issues resulting from sand, silt or debris infiltration into the optical manifold of a bulkhead connector unit, as well as exceeding the recommended mate/demate count for the connector. The tool also provides the means to retain the old optical fluid from a deployed connector and recover it for analysis.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

We claim:

1. A flush and fill tool for a bulkhead mounted optical or electro-optical connector unit, comprising:
an outer shell having a rear end, a forward end portion, and an open forward end;
a front seal assembly in the forward end portion of the outer shell configured for sealing engagement with a corresponding connector seal assembly at the forward end of a mating subsea connector unit and having at least first and second seal openings configured for alignment with corresponding openings in the connector seal assembly in a mated condition of the tool and connector unit;
the seal openings in the front seal assembly being sealed in an unmated condition of the tool;
a flush and fill assembly mounted in the outer shell behind the seal assembly, the flush and fill assembly comprising a transverse wall, at least a fill pin and a return pin projecting forward from the transverse wall and aligned with the respective first and second seal openings in the seal assembly at least in the mated condition of the tool, the fill and return pins each having a through bore, a fill reservoir and a return reservoir mounted behind the transverse wall, each reservoir having a forward end and a rear end, a first passageway connecting the forward end of the fill reservoir to the fill pin through bore and a second passageway connecting the forward end of the return reservoir to the return pin through bore;
the fill and return pins being configured to extend through the respective first and second seal openings into sealing engagement with aligned openings in the connector seal assembly to communicate with a connector contact chamber of the mating subsea connector unit in the mated condition of the tool and connector unit;
the fill reservoir containing optical fluid in an unmated start condition of the tool;
a fill plunger sealably and movably mounted in a rear end portion of the fill reservoir;
a biasing device associated with the fill plunger and configured to push the fill plunger towards the front end of the reservoir after the tool is mated with the subsea connector unit, whereby optical fluid is ejected from the fill reservoir and injected into the contact chamber in the mated connector unit through the first passageway and fill pin through bore, and used optical fluid is flushed from the contact chamber through the return pin through bore and second passageway into the return reservoir; and
the fill and return reservoirs being of predetermined volume for containing a volume of optical fluid equal to or greater than the volume of optical fluid in the connector contact chamber.

2. The flush and fill tool of claim 1, further comprising a return plunger sealably and movably mounted in the return reservoir, and a biasing device urging the return plunger into a start position at the forward end of the reservoir when the tool is in the unmated condition, whereby return fluid urges the return plunger towards the rear end of the reservoir when the fill plunger is actuated to flush old oil from the contact chamber of a mated connector unit.

3. The flush and fill tool of claim 1, further comprising a first one way valve in a fill path through the first passageway and fill pin configured to prevent backflow of used optical fluid from the connector contact chamber into the fill reservoir, and a second one way valve in a return path through the return pin and second passageway to the return reservoir configured to prevent backflow of used optical fluid from the return reservoir into the connector contact chamber.

4. The flush and fill tool of claim 1, wherein the fill and return reservoirs are pressure compensated.

5. The flush and fill tool of claim 1, further comprising a quick release device configured to retain the biasing device in an inoperative position in the unmated condition and during mating engagement with a corresponding connector unit, and to release the biasing device after the tool is mated with a subsea connector unit.

6. The flush and fill tool of claim 5, wherein the tool has an external ROV operable actuator configured for actuating the quick release device to release the biasing device to push the plunger towards the forward end of the fill reservoir.

7. The flush and fill tool of claim 1, wherein the seal assembly has a plurality of seal openings equal in number to corresponding openings in the connector seal assembly of a subsea connector unit with which the tool is to be mated, and a plurality of dummy pins extend from the transverse wall of the flush and fill assembly, the number of dummy pins being equal to the number of seal openings in addition to the first and second seal openings, each dummy pin being a solid pin of corresponding shape and dimensions to the fill and return pins and being configured to extend through the respective aligned seal openings at least in the mated condition of the tool into sealing engagement with an aligned opening in the connector seal assembly during mating of the tool with the subsea connector unit.

8. The flush and fill tool of claim 7, wherein the tool is configured for mating with a rolling seal subsea connector unit, the front seal assembly comprises a front wall and at least one cylindrical seal mounted in the front wall for alignment with a corresponding rolling seal in the mating connector unit, the seal openings at least partially comprising transverse bores in the cylindrical seal, and the cylindrical seal having a front portion projecting from the front wall and configured for sealing engagement with a corresponding front portion of the aligned rolling seal in the mating connector unit during mating engagement between the tool and connector unit.

9. The flush and fill tool of claim 8, wherein the front wall of the front seal assembly has passageways configured for receiving rolling seal actuators of the mating rolling seal connector unit during mating engagement of the tool with the connector unit.

10. The flush and fill tool of claim 8, where the front seal assembly is slidably mounted in the front end portion of the shell and movable between an advanced position spaced from the pins in the unmated condition of the tool and a retracted position in which the seal openings engage over the pins during mating of the tool with the connector unit.

11. The flush and fill tool of claim 10, further comprising a biasing spring between the fixed transverse wall and the front seal assembly which biases the front seal assembly into the advanced position in the unmated condition of the tool and during de-mating of the tool from the connector unit after the connector contact chamber has been flushed and filled with new optical fluid.

12. The flush and fill tool of claim 8, further comprising at least two cylindrical seals mounted in the front wall of the front seal assembly for alignment with a corresponding rolling seals in the mating connector unit, the cylindrical seals having the same number of transverse bores.

13. The flush and fill tool of claim 12, wherein the first and second seal openings are in the same cylindrical seal.

14. The flush and fill tool of claim 12, wherein the first seal opening extends through one of the cylindrical seals and the second seal opening extends through the other cylindrical seal.

15. A method of flushing old optical fluid from a contact chamber of a subsea fixed connector unit having a connector seal assembly movable between a sealed and closed condition when unmated and an open condition when mated with a matching flying connector unit, comprising:
aligning a flush and fill tool with a subsea fixed connector unit in place of a mating flying connector unit with one or more seals of a tool seal assembly in the forward end portion of the tool aligned with corresponding one or more seals in the forward seal assembly of the fixed connector unit;
moving the flush and fill tool into releasable mating engagement with the fixed connector unit, whereby the one or more seals in the connector seal assembly are moved from a closed position into an open position in which bores extending through the one or more seals and communicating with an optical contact chamber of the fixed connector unit are open, and pins of the flush and fill tool extend through aligned bores of corresponding one or more seals of the tool seal assembly and into sealing engagement with the bores in the fixed connector unit, one of the pins comprising a fill pin with a first bore communicating with a fill reservoir in the flush and fill tool and another of the pins comprising a return pin with a second bore communicating with a return reservoir in the flush and fill tool;
releasing a biasing device associated with a fill plunger in the fill reservoir to push the fill plunger towards the front end of the fill reservoir, whereby optical fluid is ejected from the fill reservoir and injected into the contact chamber in the mated fixed connector unit through the first bore of the fill pin, and used optical fluid is flushed from the contact chamber through the second bore of the return pin through bore into the return reservoir; and
when at least substantially all used optical fluid has been flushed from the contact chamber and replaced with optical fluid from the fill reservoir, separating the flush and fill tool from the fixed connector unit so that the pins are retracted back out of the one or more seals of the connector seal assembly and the one or more seals of the connector seal assembly are moved back into a closed and sealed condition in which the bores do not communicate with the optical contact chamber and the optical contact chamber is closed and sealed.

16. A flush and fill tool for a bulkhead mounted optical or electro-optical connector unit, comprising:
an outer shell having a rear end, a forward end portion, and an open forward end;
a tool seal assembly in the forward end portion of the outer shell having one or more seals configured for sealing engagement with corresponding seals in a connector seal assembly of a subsea fixed connector unit with which the flush and fill tool is configured to engage in a mated condition of the tool and connector unit, the one or more seals of the tool seal assembly having the same number of openings as the one or more seals of the connector seal assembly, the openings in the one or more seals of the tool seal assembly being configured for alignment with the seal openings of the connector seal assembly at least in the mated condition of the tool and fixed connector unit in which the seals of the connector seal assembly are open and in communication with an optical contact chamber of the fixed connector unit;
a flush and fill manifold mounted in the outer shell behind the tool seal assembly and having a plurality of pins equal in number to the openings in the one or more seals of the tool seal assembly, the pins being configured to extend through respective seal openings of the tool seal assembly and into sealing engagement with aligned openings of the one or more seals of the fixed connector unit in the mated condition of the tool and fixed connector unit;
a first pin and a second pin of the plurality of pins having through bores and the remainder of the pins comprising solid dummy pins;
a fill reservoir and a return reservoir associated with the flush and fill manifold, each reservoir having a forward end and a rear end, the forward end of the fill reservoir having a first opening and the forward end of the return reservoir having a second opening, the first and second openings being in communication with the respective through bores of the first and second pins at least in a flush and fill condition of the flush and fill tool;
the fill reservoir containing optical fluid in an unmated start condition of the tool;
a fill plunger sealably and movably mounted in a rear end portion of the fill reservoir;
a biasing device associated with the fill plunger and configured to push the fill plunger towards the front end of the reservoir in a flush and fill condition of the tool after the tool is mated with the subsea connector unit, whereby optical fluid is ejected from the fill reservoir and injected into the contact chamber in the mated connector unit through the first pin through bore, and used optical fluid is flushed from the contact chamber through the second pin through bore into the return reservoir.

17. The flush and fill tool of claim 16, wherein the pins are configured to extend at least partially through the seal openings of the fixed connector unit in the mated condition of the tool and connector unit.

18. The flush and fill tool of claim 16, wherein at least the first and second pins have forward ends which are configured to extend through the seal openings of the fixed connector unit and into the optical contact chamber into a position spaced from aligned optical contacts in the chamber in the mated condition of the tool and connector unit.

19. The flush and fill tool of claim 16, wherein the one or more seals of the tool seal assembly comprise one or more cylindrical seals of shape and dimensions matching cylindrical rolling seals of a fixed subsea connector unit with which the flush and fill tool is configured to mate.

20. The flush and fill tool of claim 19, wherein the one or more cylindrical seals are fixed, non-rolling seals and the seal openings have forward ends which are sealed in the unmated condition of the tool.
